(19) United States
(12) Patent Application Publication
(10) Pub. No.: US 2021/0178712 A1
(43) Pub. Date: Jun. 17, 2021

(54) METHOD FOR MANUFACTURING WORM WHEEL

(71) Applicant: KYB Corporation, Tokyo (JP)

(72) Inventor: Shinraku YOSHIKAWA, Gifu (JP)

(21) Appl. No.: 16/087,096

(22) PCT Filed: Feb. 16, 2017
(86) PCT No.: PCT/JP2017/005739

§ 371 Date: Sep. 21, 2018

(30) Foreign Application Priority Data
Mar. 28, 2016 (JP) 2016-063851

(51) Int. Cl. B29D 15/00; F16H 55/22; F16H 55/06

(52) U.S. Cl. CPC B29D 15/00; F16H 2055/065; F16H 55/06; F16H 55/22

(57) ABSTRACT

The method for manufacturing the worm wheel includes a step of combining the first molds for molding the first tooth surfaces of the wheel teeth to be pushed by the shaft tooth when the worm shaft rotates in the direction and the second molds for molding the second tooth surfaces of the wheel teeth to be pushed by the shaft tooth when the worm shaft rotates in the direction to form the cavities defined by the first molds and the second molds, a step of injecting the molten resin into the cavities to mold the wheel teeth, and a step of separating the first molds and the second molds from each other in the direction oblique to the tooth traces of the wheel teeth.

### TECHNICAL FIELD

The present invention relates to a method for manufacturing a worm wheel.

### BACKGROUND ART

An electric power steering device is known which transmits a rotational force of an electric motor to a rack shaft via a worm shaft and a worm wheel. The worm wheel includes a plurality of teeth to be meshed with a tooth of the worm shaft. Each of the teeth of the worm wheel has a first tooth surface to be pushed by the tooth of the worm shaft when the worm shaft rotates in a predetermined direction and a second tooth surface to be pushed by the tooth of the worm shaft when the worm shaft rotates in a reverse direction.

JP2013-160334A discloses a worm wheel in which parts of first tooth surfaces and parts of second tooth surfaces are in the form of concave curved surfaces. Specifically, a substantially half area of the tooth surface is formed as a concave curved surface part and the other area is formed as a helical surface part. The concave curved surface part is formed so as to be more away from a tooth trace from a center toward an end of the tooth, and the helical surface part is formed in parallel to the tooth trace.

Further, JP2013-160334A discloses a method for manufacturing a worm wheel using a molding mold dividable into first molds and second molds. The first mold has a first molding surface for molding a first tooth surface and the second mold has a second molding surface for molding a second tooth surface. The first and second molds are so combined with each other that the first molding surfaces and the second molding surfaces face each other while being spaced apart and first dividing surfaces of the first molds opposite to the first molding surfaces are in contact with second dividing surfaces of the second molds opposite to the second molding surfaces. Cavities for molding teeth of the worm wheel are defined by the first and second molding surfaces. The molded worm wheel is removed from the first and second molds by separating the first and second molds from each other along a tooth trace direction.

### SUMMARY OF INVENTION

If a worm wheel is meshed with a worm shaft, contact surface pressures are produced on the teeth of the worm wheel. These contact surface pressures are reduced by forming curved surface parts of first and second tooth surfaces into shapes corresponding to a tooth of the worm shaft and increasing contact areas of the tooth of the worm shaft and the teeth of the worm wheel. To further reduce the contact surface pressures, it is desired to make the curved surface parts larger.

However, in the method disclosed in JP2013-160334A, the first and second molds are separated from each other in the tooth trace direction in removing the molded worm wheel from the first and second molds. To separate the first and second molds from each other in the tooth trace direction, the first and second dividing surfaces need to be formed in parallel to the tooth trace direction. Thus, the curved surface parts of the first and second tooth surfaces cannot be made larger.

If the curved surface parts of the first and second tooth surfaces are made larger, the first molding surface of the first mold and the second molding surface of the second mold are not only formed so as to be more away from the tooth trace from the center toward one end of the tooth, but also formed so as to be more away from the tooth trace from the center toward the other end of the tooth. Since the first and second dividing surfaces are formed along the tooth trace, central parts of the first and second molds are thicker than both end parts. Thus, the first and second molds cannot be withdrawn from the molded worm wheel.

As just described, the curved surface parts of the first and second tooth surfaces cannot be made larger by the method disclosed in JP 2013-160334A.

The present invention aims to make curved surface parts of tooth surfaces of a worm wheel larger while forming the curved surface parts into shapes corresponding to a tooth of a worm shaft.

According to one aspect of the present invention, a method for manufacturing a worm wheel including a plurality of wheel teeth to be meshed with a shaft tooth of a worm shaft includes a step of combining first molds for molding first tooth surfaces of the wheel teeth to be pushed by the shaft tooth when the worm shaft rotates in a predetermined direction and second molds for molding second tooth surfaces of the wheel teeth to be pushed by the shaft tooth when the worm shaft rotates in a reverse direction to form cavities defined by the first molds and the second molds; a step of injecting molten material into the cavities to mold the wheel teeth; and a step of separating the first molds and the second molds from each other in a direction oblique to tooth traces of the wheel teeth.

### BRIEF DESCRIPTION OF DRAWINGS

FIG. 1 is a side view of a worm wheel manufactured by a manufacturing method according to an embodiment of the present invention, showing a state where the worm wheel is meshed with a worm shaft;

FIG. 2 is a perspective view showing a part of the worm wheel in FIG. 1;

FIG. 3 is a partial development view of a pitch cylindrical surface of the worm wheel in FIG. 2;

FIG. 4 is a view for explaining a manufacturing method according to the embodiment of the present invention, showing a state where first molds and second molds are combined;

FIG. 5 is a view for explaining the manufacturing method according to the embodiment of the present invention, showing a state where molten resin is injected in cavities;

FIG. 6 is a view for explaining the manufacturing method according to the embodiment of the present invention, showing a state where the first and second molds are separated from each other;

FIG. 7 is a view for explaining a manufacturing method according to a comparative example; and

FIG. 8 is a view for explaining a manufacturing method according to a modification of the embodiment of the present invention.

### DESCRIPTION OF EMBODIMENTS

Hereinafter, a method for manufacturing a worm wheel 10 according to an embodiment of the present invention is described with reference to the drawings.

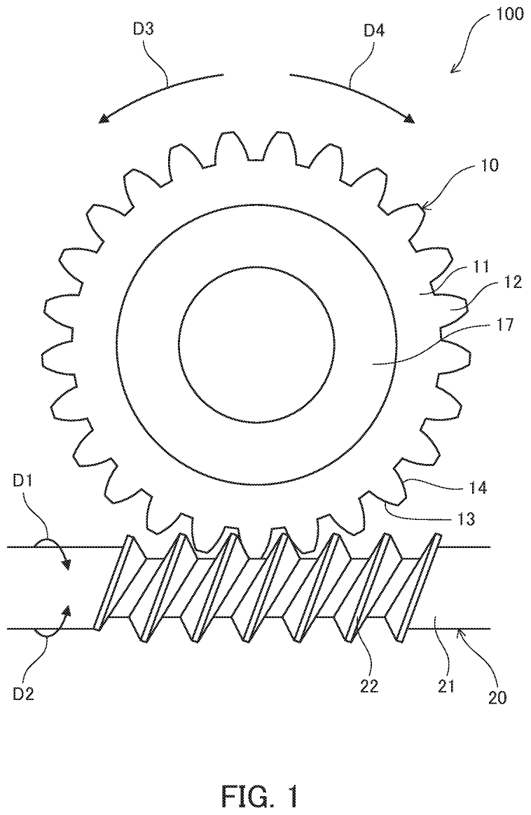

As shown in FIG. 1, the worm wheel 10 is used in a worm speed reducer 100. In the worm speed reducer 100, the worm wheel 10 is meshed with a worm shaft 20. The worm shaft 20 is coupled to a rotary shaft (not shown) of a motor, and the worm wheel 10 is coupled, for example, to a pinion (not shown). A rotational force output from the motor is transmitted to a rack shaft for turning wheels through the worm wheel 10 and the pinion and assists the steering of the wheels by a driver.

When the worm shaft 20 rotates according to the rotation of the rotary shaft of the motor, the worm wheel 10 rotates. At this time, the rotation of the worm shaft 20 is decelerated and transmitted to the worm wheel 10. The pinion rotates according to the rotation of the worm wheel 10. In this way, the worm speed reducer 100 decelerates and transmits the rotation of the motor to the pinion via the worm shaft 20 and the worm wheel 10.

The worm shaft 20 includes a cylindrical shaft body 21 and a shaft tooth 22 spirally formed on an outer periphery of the shaft body 21. The worm wheel 10 includes a ring-shaped wheel body 11 and a plurality of wheel teeth 12 projecting from an outer periphery of the wheel body 11. A pitch of the wheel teeth 12 is substantially equal to a pitch of the shaft tooth 22 and the wheel teeth 12 are meshed with the shaft tooth 22.

The wheel body 11 and the wheel teeth 12 are integrally molded from a resin material. A sleeve 17 made of metal is provided on an inner periphery of the wheel body 11.

The wheel teeth 12 are formed on an outer periphery of the worm wheel 10. Further, the wheel teeth 12 have first and second tooth surfaces 13, 14 intersecting with a circumferential direction of the worm wheel 10. The second tooth surface 14 is located on a side of the wheel teeth 12 opposite to the first tooth surface 13.

When the worm shaft 20 rotates in a predetermined direction (direction D1 shown in FIG. 1), the first tooth surfaces 13 of the wheel teeth 12 are pushed by the shaft tooth 22. As a result, the worm wheel 10 rotates in a direction D3 shown in FIG. 1. When the worm shaft 20 rotates in a reverse direction (direction D2 shown in FIG. 1), the second tooth surfaces 14 of the wheel teeth 12 are pushed by the shaft tooth. 22. As a result, the worm wheel 10 rotates in a direction D4 shown in FIG. 1.

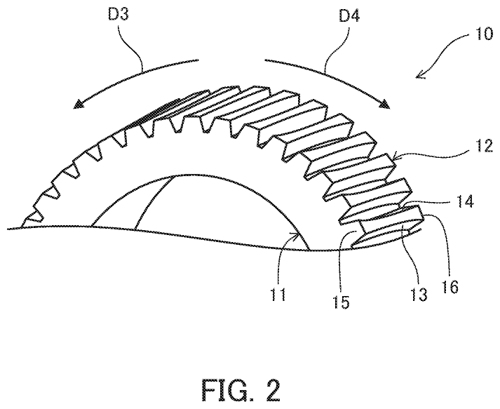

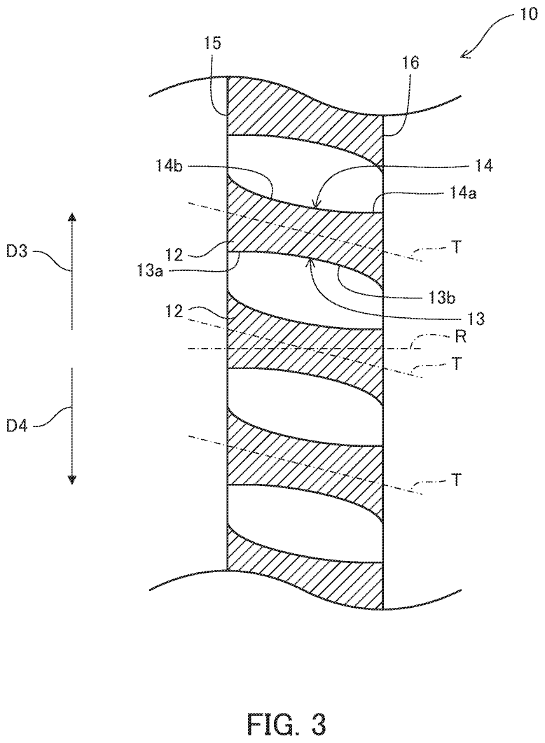

FIG. 2 is a perspective view showing a part of the worm wheel 10. FIG. 3 is a partial development view of a pitch cylindrical surface of the worm wheel 10.

As shown in FIGS. 2 and 3, the wheel teeth 12 further have first and second end surfaces 15, 16 perpendicular to a direction along a rotation axis R of the worm wheel 10 (hereinafter, merely referred to a “rotation axis direction”). The second end surface 16 is located on a side of the wheel teeth 12 opposite to the first end surface 15.

As shown in FIG. 3, the first tooth surface 13 has a flat surface part 13a formed into a flat surface from the first end surface 15 along the rotation axis R of the worm wheel 10 and a curved surface part 13b formed into a curved surface from the flat surface part 13a to the second end surface 16. The curved surface part 13b is formed by being curved in the direction D4 from the flat surface part 13a in correspondence with the shaft tooth 22 (see FIG. 1) of the worm shaft 20.

Similarly to the first tooth surface 13, the second tooth surface 14 has a flat surface part 14a and a curved surface part 14b. The flat surface part 14a is formed into a flat surface from the second end surface 16 along the rotation axis R of the worm wheel 10. The curved surface part 14b is formed into a curved surface shaped in correspondence with the shaft tooth 22 of the worm shaft 20.

Since the curved surface part 13b is formed on the first tooth surface 13 and the curved surface part 14b is formed on the second tooth surface 14, a tooth trace direction of the wheel teeth 12 is inclined with respect to the rotation axis direction.

Here, “tooth trace” means a virtual line passing through a center of the first end surface 15 and a center of the second end surface 16 and is represented by a dashed-dotted line denoted by reference sign “T” in FIG. 3. “Tooth trace direction” means a direction along the tooth trace T.

Since the first tooth surface 13 has the curved surface part 13b, a contact area of the first tooth. surface 13 and the shaft tooth 22 when the worm shaft 20 rotates in the direction D1 can be increased as compared to the case where the entire first tooth surface 13 is formed only by the flat surface part 13a. Similarly, since the second tooth surface 14 has the curved surface part 14b, a contact area of the second tooth surface 14 and the shaft tooth 22 when the worm shaft 20 rotates in the direction D2 can be increased as compared to the case where the entire second tooth surface 14 is formed only by the flat surface part 14a.

By increasing the contact areas of the first and second tooth surfaces 3, 14 and the shaft tooth 22, contact surface pressures produced on the first and second tooth surfaces 13, 14 can be reduced. Thus, the durability of the wheel teeth 12 can be improved.

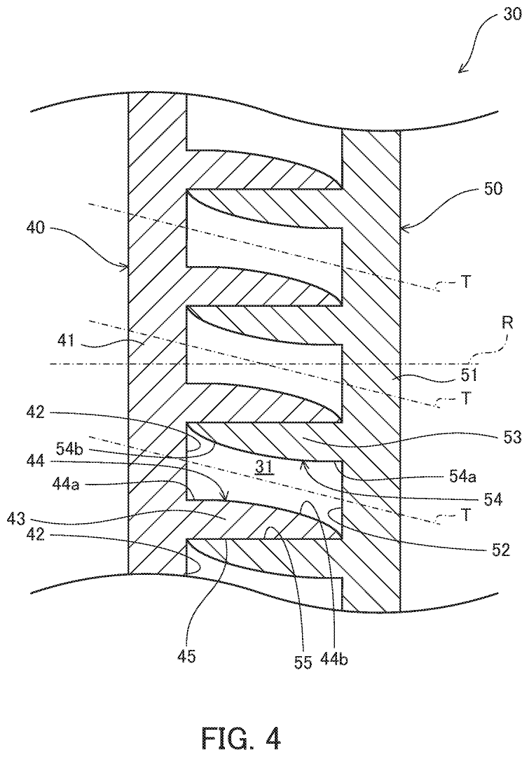

Next, a mold 30 for molding the wheel teeth 12 of the worm wheel 10 is described with reference to FIGS. 4 to 6. The mold 30 is formed so as to be dividable into a first mold block 40 and a second mold block 50.

The first mold block 40 includes a plurality of first molds 43 for molding the first tooth surfaces 13 (see FIG. 3) of the wheel teeth 12. The first mold 43 projects from a body part 41 of the first mold block 40. A flat surface part 44a and a curved surface part 44b are formed on a molding surface 44 of the first mold 43 in correspondence with the first tooth surface 13. That is, the flat surface part 44a is formed into a flat surface along the rotation axis R and the curved surface part 44b is formed by being curved in the direction D4 from the flat surface part 44a.

The second mold block 50 includes a plurality of second molds 53 for molding the second tooth surfaces 14 (see FIG. 3) of the wheel teeth 12. The second mold 53 projects from a body part 51 of the second mold block 50. A flat surface part 54a and a curved surface part 54b are formed on a molding surface 54 of the second mold 53 in correspondence with the second tooth surface 14.

With the first and second mold blocks 40, 50 combined, the molding surfaces 44 and the molding surfaces 54 face each other while being spaced apart. Tips of the first molds 43 are in contact with a side surface 52 of the body part 51 of the second mold block 50. Tips of the second molds 53 are in contact with a side surface 42 of the body part 41 of the first mold block 40.

A cavity 31 for molding the wheel teeth 12 (see FIG. 3) is defined by the molding surfaces 44, 54 and the side surfaces 42, 52. That is, the side surface 42 of the body part 41 molds the first end surface 15 of the wheel teeth 12 and the side surface 52 of the body part 51 molds the second end surface 16 of the wheel teeth 12.

Further, with the first and second mold blocks 40, 50 combined, surfaces 45 of the first molds 43 opposite to the molding surfaces 44 and surfaces 55 of the second molds 53 opposite to the molding surfaces 54 are in contact with each other. That is, the mold 30 is dividable with the surfaces 45, 55 as boundaries. The “surface 45” and the “surface 55” are also respectively referred to as a “dividing surface 45” and a “dividing surface 55”.

Next, a method for manufacturing the worm wheel 10, more specifically a method for molding the wheel teeth 12, is described.

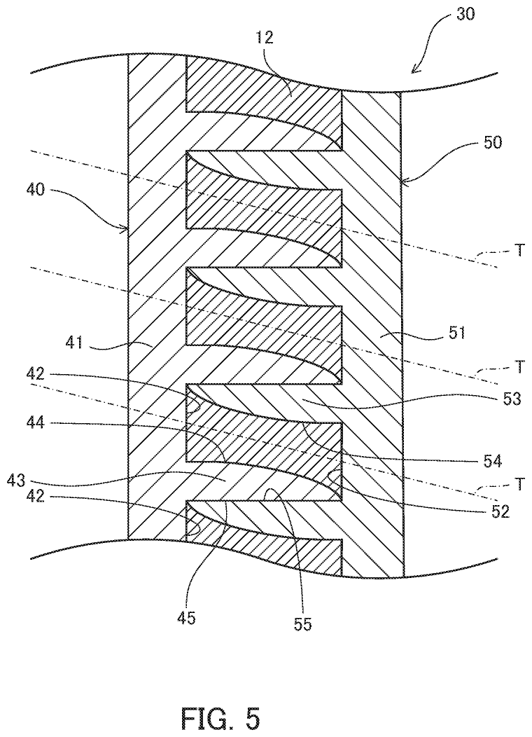

First, as shown in FIG. 4, the first and second mold blocks 40, 50 are combined to form the cavities 31. Subsequently, as shown in FIG. 5, molten resin is injected into the cavities 31 and cooled. The resin is cured into a shape corresponding to the shape of the cavities 31 to mold the wheel teeth 12 made of resin.

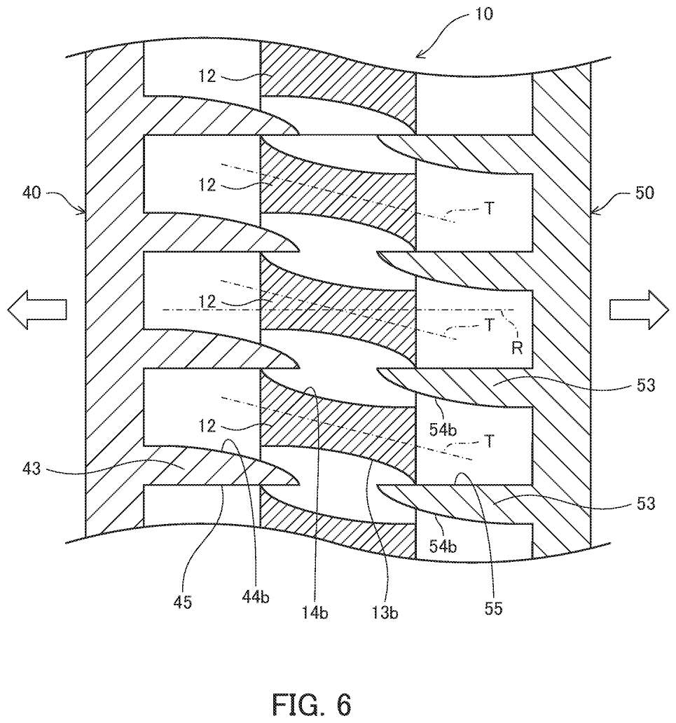

Subsequently, as shown in FIG. 6, the first and second mold blocks 40, 50 are separated from each other in the rotation axis direction. As a result, the molded worm wheel 10 is removed from the first and second mold blocks 40, 50.

Since the first and second mold blocks 40, 50 are separated from each other in the rotation axis direction in the present embodiment, the dividing surfaces 45 of the first mold block 40 and the dividing surfaces 55 of the second mold block 50 are formed along the rotation axis R of the worm wheel 10.

The curved surface part 44b of the first mold 43 is formed by being curved in the direction D4 from the flat surface part 44a along the rotation axis R as described above. Since the dividing surface 45 of the first mold 43 is formed along the rotation axis R, the curved surface part 44b is formed by being curved so as to approach the dividing surface 45 from the flat surface part 44a toward the tip of the first mold 43. Thus, the first mold 43 is formed so as to become narrower from a base end (end part of the first mold 43 in a separation direction of the first mold 43) toward the tip. Thus, the first molds 43 can be withdrawn from the molded worm wheel 10.

Similarly, the curved surface part 54b of the second mold 53 is formed by being curved in the direction D3 from the flat surface part 54a along the rotation axis R. Since the dividing surface 55 of the second mold 53 is formed along the rotation axis R, the curved surface part 54b is formed by being curved so as to approach the dividing surface 55 from the flat surface part 54a toward the tip of the second mold 53. Thus, the second mold 53 is formed so as to become narrower from a base end (end part of the second mold 53 in a separation direction of the second mold 53) toward the tip. Thus, the second molds 53 can be withdrawn from the molded worm wheel 10.

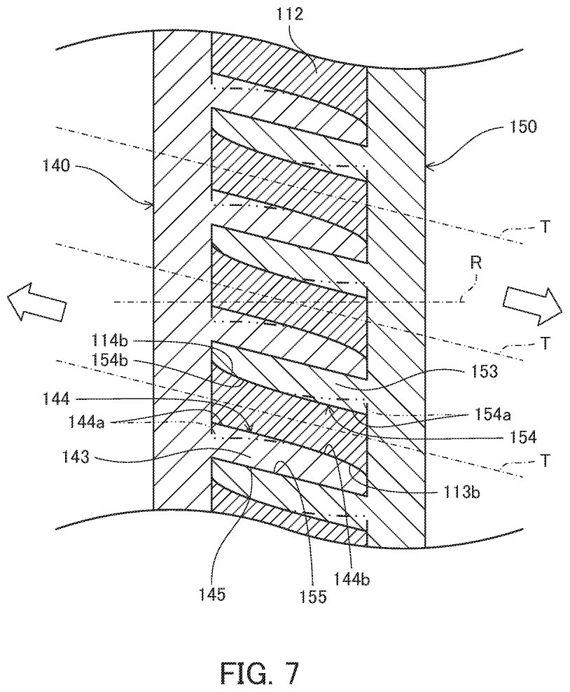

Here, a worm wheel manufacturing method according to a comparative example is described with reference to FIG. 7. Also in the comparative example, a first mold block 140 includes a plurality of first molds 143 each having a molding surface 144 and a dividing surface 145, and a second mold block 150 includes a plurality of second molds 153 each having a molding surface 154 and a dividing surface 155. A flat surface part 144a and a curved surface part 144b are formed on the molding surface 144, and a flat surface part 154a and a curved surface part 154b are formed on the molding surface 154.

In the comparative example, the first and second mold blocks 140, 150 are separated from each other in a tooth trace direction of wheel teeth 112. In this case, the dividing surface 145 of the first mold 143 is formed along a tooth trace T. Thus, the flat surface part 144a of the first mold 143 is formed along the tooth trace T, and the curved surface part 144b of the first mold 143 is formed by being curved in the direction D4 from the flat surface part 144a.

If the flat surface part 144a is formed along the rotation axis R as shown by a chain double-dashed line in FIG. 7 in the comparative example, the flat surface part 144a extends more away from the dividing surface 145 from a base end toward the curved surface part 144b. Further, if the curved surface part 144b is formed by being curved from the flat surface part 144a, a part of the curved surface part 144b is curved so as to be more away from the dividing surface 145 from the flat surface part 144a toward a center of the first mold 143. Thus, the first mold 143 is formed so as to become thicker from the base end toward the center. Therefore, the first molds 143 cannot be withdrawn from the molded worm wheel.

As just described, in the comparative example, the curved surface part 144b is formed by being curved from the flat surface part 144a since the flat surface part 144a is formed along the tooth trace T. That is, in the comparative example, the flat surface part 144a cannot be formed obliquely to the tooth trace T, and the curved surface part 144b cannot be formed so as to approach the tooth trace T from the flat surface part 144a toward the center of the first mold 143.

Since a first tooth surface 113 of the wheel teeth 112 is molded into a shape corresponding to the shape of the molding surface 144 of the first mold 143, a flat surface part 113a of the wheel teeth 112 cannot be formed obliquely to the tooth trace T. Further, a curved surface part 113b of the wheel teeth 112 cannot be curved so as to approach the tooth trace T from the flat surface part 113a toward a center of the wheel teeth 112. Thus, the curved surface part 113b of the wheel teeth 112 cannot be made larger while being formed into a shape corresponding to the shaft tooth 22 (see FIG. 1) of the worm shaft 20.

Similarly, in the comparative example, the dividing surface 155 of the second mold 153 needs to be formed along the tooth trace T. Thus, a flat surface part 114a of the wheel teeth 112 cannot be formed obliquely to the tooth trace T and a curved surface part 114b cannot be curved so as to approach the tooth trace T from the flat surface part 114a toward the center of the wheel teeth 112. Thus, the curved surface part 114b of the wheel teeth 112 cannot be made larger while being formed into a shape corresponding to the shaft tooth 22 (see FIG. 1) of the worm shaft 20.

Since the first mold block 40 is separated from the second mold block 50 in the rotation axis direction as shown in FIG. 6 in the present embodiment, the dividing surface 45 of the first mold 43 is formed along the rotation axis R. Thus, the flat surface part 44a of the first mold 43 formed along the rotation axis R extends along the dividing surface 45. Further, the curved surface part 44b formed by being curved from the flat surface part 44a is curved so as to approach the dividing surface 45 from the flat surface part 44a toward the tip of the first mold 43. Thus, the first mold 43 is formed so as to become narrower from the base end toward the tip. Therefore, the first molds 43 can be withdrawn from the molded worm wheel 10.

As just described, in the present embodiment, the flat surface part 44a can be formed along the rotation axis R and the curved surface part 44b can be formed by being curved from the flat surface part 44a. That is, the flat surface part 44a can be formed obliquely to the tooth trace T, and the curved surface part 44b can be formed so as to approach the tooth trace T from the flat surface part 44a toward the center of the first mold 43.

Since the first tooth surface 13 of the wheel teeth 12 is formed into a shape corresponding to the shape of the molding surface 44 of the first mold 43, the flat surface part 13a of the wheel teeth 12 can be formed obliquely to the tooth trace T. Further, the curved surface part 13b of the wheel teeth 12 can be curved so as to approach the tooth trace T from the flat surface part 13a toward the center of the wheel teeth 12. Thus, the curved surface part 13b of the wheel teeth 12 can be made larger while being formed into a shape corresponding to the shaft tooth 22 (see FIG. 1) of the worm shaft 20.

Similarly, the dividing surface 55 of the second mold 53 is formed along the rotation axis R. Thus, the flat surface part 14a of the wheel teeth 12 can be formed obliquely to the tooth trace T, and the curved surface part 14b can be curved so as to approach the tooth trace T from the flat surface part 14a toward the center of the wheel teeth 12. Thus, the curved surface part 14b of the wheel teeth 12 can be made larger while being formed into a shape corresponding to the shaft tooth 22 (see FIG. 1) of the worm shaft 20.

Further, since the first mold 43 is separated from the second mold 53 in the rotation axis direction in the present embodiment, the dividing surface 45 of the first mold 43 is formed along the rotation axis R. Thus, the molding surface 44 can be formed by being curved more away from the tooth trace T from the center toward the base end until a tangent to the molding surface 44 becomes parallel to the rotation axis R. Similarly, the molding surface 54 can be formed by being curved more away from the tooth trace T from the center toward the base end until a tangent to the molding surface 54 becomes parallel to the rotation axis R. Thus, the curved surface parts 13b, 14b of the wheel teeth 12 can be made larger while being formed into shapes corresponding to the shaft tooth 22.

Although the flat surface part 13a and the curved surface part 13b are formed on the first tooth surface 13 in the present embodiment, the entire first tooth surface 13 may be formed into a curved surface. Similarly, the entire second tooth surface 14 may be formed into a curved surface. That is, the entire first tooth surface 13 may be formed into a curved surface using the first mold 43 and the entire second tooth surface 14 may be formed into a curved surface using the second mold 53.

Since the entire first tooth surface 13 may be formed into a curved surface using the first mold 43 and the entire second tooth surface 14 may be formed into a curved surface using the second mold 53, the wheel teeth 12 formed by molding need not be processed in forming the entire first and second tooth surfaces 13, 14 into curved surfaces. Thus, the curved surface parts 13b, 14b of the first and second tooth surfaces 13, 14 can be made larger with fewer man-hours.

The separation of the first and second mold blocks 40, 50 is not limited to the one along the rotation axis direction, and the first and second mold blocks 40, 50 may be separated in a direction oblique to the tooth traces T of the wheel teeth 12. Also in this case, the dividing surfaces 45, 55 of the first and second mold blocks 40, 50 are formed obliquely to the tooth traces T. Thus, the molding surfaces 44, 54 of the first and second molds 43, 53 can be formed by being curved more away from the tooth traces T from the centers toward the base ends. Therefore, the curved surface parts 13b, 14b of the wheel teeth 12 can be made larger while being formed into shapes corresponding to the shaft tooth 22.

The separation direction of the first and second mold blocks 40, 50 is preferably inclined toward the rotation axis R with respect to the tooth traces T. In this case, the dividing surfaces 45, 55 are inclined toward the rotation axis R with respect to the tooth traces T. Thus, the molding surfaces 44, 54 of the first and second molds 43, 53 can be formed by being curved more away from the tooth traces T from the centers toward the vicinities of the base ends. Therefore, the curved surface parts 13b, 14b can be made larger while being formed into shapes corresponding to the shaft tooth 22.

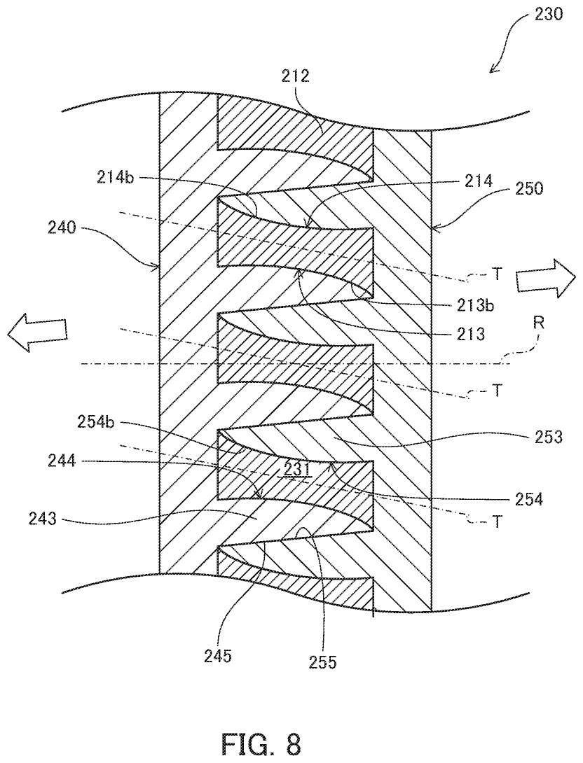

FIG. 8 is a view for explaining a manufacturing method according to a modification of the present embodiment, showing wheel teeth 212 manufactured by this manufacturing method and a mold 230 used in this manufacturing method. Cavities 231 for molding the wheel teeth 212 (see FIG. 3) are defined by a first mold block 240 and a second mold block 250.

Dividing surfaces 245 of the first mold block 240 are inclined from tooth traces T toward the rotation axis R and beyond the rotation axis R. Similarly, dividing surfaces 255 of the second mold block 250 are inclined from the tooth traces T toward the rotation axis R and beyond the rotation axis R. In the mold 230, the first and second mold blocks 240, 250 are separated along the dividing surfaces 245, 255, i.e. in a direction inclined from the tooth traces T toward the rotation axis R and beyond the rotation axis R after the wheel teeth 212 are molded.

In the manufacturing method according to the modification, molding surfaces 244, 254 on base ends of first and second molds 243, 253 can be formed into curved surfaces until the molding surfaces 244, 245 become parallel to the dividing surfaces 245, 255. Thus, curved surface parts 213b, 214b of first and second tooth surfaces 213, 214 of the wheel teeth 212 can be enlarged, and a contact area of the wheel teeth 212 and the shaft tooth 22 (see FIG. 1) can be made larger.

The configuration, functions and effects of the embodiment of the present invention are summarized below.

The present embodiment relates to the method for manufacturing the worm wheel 10 including the plurality of wheel teeth 12, 212 to be meshed with the shaft tooth 22 of the worm shaft 20. The method for manufacturing the worm wheel 10 includes a step of combining the first molds 43, 243 for molding the first tooth surfaces 13, 213 of the wheel teeth 12, 212 to be pushed by the shaft tooth 22 when the worm shaft 20 rotates in the direction D1 and the second molds 53, 253 for molding the second tooth surfaces 14, 214 of the wheel teeth 12, 212 to be pushed by the shaft tooth 22 when the worm shaft 20 rotates in the direction D2 to form the cavities 31, 231 defined by the first molds 43, 243 and the second molds 53, 354, a step of injecting the molten resin into the cavities 31, 231 to mold the wheel teeth 12, 212, and a step of separating the first molds 43, 243 and the second molds 53, 253 from each other in. the direction. oblique to the tooth traces T of the wheel teeth 12, 212.

Since the first molds 43, 243 and the second molds 53, 253 are separated from each other in the direction oblique to the tooth traces T in this configuration, the dividing surfaces 45, 245, 55, 255 of the first molds 43, 243 and the second molds 53, 253 are formed obliquely to the tooth traces T. Thus, the molding surfaces 44, 244, 54, 254 of the first molds 43, 243 and the second molds 53, 253 can be formed by being curved more away from the tooth traces T from the centers toward the base ends. Therefore, the curved surface parts 13b, 213b, 14b, 214b of the wheel teeth 12, 212 can be made larger while being formed into shapes corresponding to the shaft tooth 22.

Further, in the method for manufacturing the worm wheel 10, the first molds 43, 243 and the second molds 53, 253 are separated from each other in the direction inclined toward the rotation axis R with respect to the tooth traces T of the wheel teeth 12, 212.

Since the first molds 43, 243 and the second molds 53, 253 are separated from each other in the direction inclined toward the rotation axis R with respect to the tooth traces T of the wheel teeth 12, 212 in this configuration, the dividing surfaces 45, 245, 55, 255 of the first molds 43, 243 and the second molds 53, 253 are formed by being inclined toward the rotation axis R with respect to the tooth traces T. Thus, the molding surfaces 44, 244, 54, 254 of the first molds 43, 243 and the second molds 53, 253 can be formed by being curved more away from the tooth traces T from the centers toward the vicinities of the base ends. Therefore, the curved surface parts 13b, 213b, 14b, 214b of the wheel teeth 12, 212 can be made larger while being formed into shapes corresponding to the shaft tooth 22.

Further, in the method for manufacturing the worm wheel 10, the first molds 43 and the second molds 53 are separated from each other in the direction along the rotation axis R of the worm wheel 10.

Since the first molds 43 and the second molds 53 are separated from each other in the rotation axis direction, the dividing surfaces 45, 55 of the first molds 43 and the second molds 53 are formed along the rotation axis R. Thus, the molding surfaces 44, 54 can be formed by being curved more away from the tooth traces T from the centers toward the base ends until the tangents to the molding surfaces 44, 54 become parallel to the rotation axis R. Therefore, the curved surface parts 13b, 14b of the wheel teeth 12 can be made larger while being formed into shapes corresponding to the shaft tooth 22.

Further, in the method for manufacturing the worm wheel 10, the entire first tooth surfaces 13, 213 are formed into curved surfaces using the first molds 43, 243 and the entire second tooth surfaces 14, 214 are formed into curved surfaces using the second molds 53, 253.

Since the entire first tooth surfaces 13, 213 are formed into curved surfaces using the first molds 43, 243 and the entire second tooth surfaces 14, 214 are formed into curved surfaces using the second molds 53, 253, the wheel teeth 12, 212 formed by molding need not be processed in forming the entire first and second tooth surfaces 13, 213, 14, 214 into curved surfaces. Therefore, the curved surface parts 13b, 213b, 14b, 214b of the wheel teeth 12, 212 can be made larger with fewer man-hours.

The embodiments of the present invention described above are merely illustration of some application examples of the present invention and not of the nature to limit the technical scope of the present invention to the specific constructions of the above embodiments.

For example, in the above embodiment, the wheel teeth 12, 212 are made of resin. Instead of resin, the wheel teeth 12, 212 may be formed from a meltable material.

The present application claims a priority based on Japanese Patent Application No. 2016-63851 filed with the Japan Patent Office on Mar. 28, 2016, all the contents of which are hereby incorporated by reference.

1. A method for manufacturing a worm wheel including a plurality of wheel teeth to be meshed with a shaft tooth of a worm shaft, comprising:
a step of combining first molds for molding first tooth surfaces of the wheel teeth to be pushed by the shaft tooth when the worm shaft rotates in a predetermined direction and second molds for molding second tooth surfaces of the wheel teeth to be pushed by the shaft tooth when the worm shaft rotates in a reverse direction to form cavities defined by the first molds and the second molds;
a step of injecting molten material into the cavities to mold the wheel teeth; and
a step of separating the first molds and the second molds from each other in a direction oblique to tooth traces of the wheel teeth.

2. The method for manufacturing the worm wheel according to claim 1, wherein
the first molds and the second molds are separated from each other in a direction inclined toward a rotation axis of the worm wheel with respect to the tooth traces of the wheel teeth.

3. The method for manufacturing the worm wheel according to claim 1, wherein
the first molds and the second molds are separated from each other in a direction along a rotation axis of the worm wheel.

4. The method for manufacturing the worm wheel according to claim 1, wherein
the entire first tooth surfaces are formed into curved surfaces using the first molds and the entire second tooth surfaces are formed into curved surfaces using the second molds.
